(19) United States
(12) Patent Application Publication
(10) Pub. No.: US 2015/0102070 A1
(43) Pub. Date: Apr. 16, 2015

(54) CONTAINER FOR HANDLING AND TRANSPORTING OF HIGH-PURITY AND ULTRA-HIGH-PURITY CHEMICALS

(71) Applicants: Ekkehard Mueh, Rheinfelden (DE); Hartwig Rauleder, Rheinfelden (DE); Bernd Nowitzki, Marl (DE); Harald Klein, Shanghai (CN)

(72) Inventors: Ekkehard Mueh, Rheinfelden (DE); Hartwig Rauleder, Rheinfelden (DE); Bernd Nowitzki, Marl (DE); Harald Klein, Shanghai (CN)

(73) Assignee: EVONIK DEGUSSA GMBH, Essen (DE)

(21) Appl. No.: 14/383,757

(22) PCT Filed: Feb. 11, 2013
(86) PCT No.: PCT/EP2013/052641

§ 371 Date: Sep. 8, 2014

(30) Foreign Application Priority Data
Mar. 27, 2012 (DE) 10 2012 204 902.9

(51) Int. Cl. B67D 7/02; B65B 3/00; B67D 7/84

(52) U.S. Cl. CPC B67D 7/0294; B67D 7/84; B65B 3/00
USPC 222/400.7; 222/464.1; 53/473; 222/464.7

(57) ABSTRACT

The invention relates to an empty container (1) for accommodating high-purity and ultra-high-purity, air- and/or moisture-sensitive liquid or condensable compounds, comprising a cylindrical jacket (3), a bottom (4a) and an upper end piece (4b, 4b′) at the two ends of the cylindrical jacket, an associated connection unit (2) including shut-off/multiple-way and rinsing system (5), and an associated immersion pipe (7), characterized in that the lower end of the immersion pipe (7a) protrudes into a recess (4c) (depression), which is introduced in the bottom (4a) and which is the lowest point of the bottom, and/or the lower end of the immersion pipe (7a) is tapered and is brought close to the lowest point of the bottom (4a) to within less than 2 mm by means of the tip of the tapered immersion pipe (7b) or touches the lowest point of the bottom with the tip of the tapered immersion pipe (7b). The invention further relates to the use of empty containers according to the invention for storing, handling, and/or transporting such high-purity and ultra-high-purity compounds.

The invention relates to specifically designed empty containers for accommodating high-purity and ultrahigh-purity, air- and/or moisture-sensitive chemicals, having a unit for connecting, charging, emptying and flushing this empty container, and also its use.

For example, silicon compounds used in microelectronics have to meet particularly high purity requirements. Such silicon compounds are required, inter alia, for producing highly pure, thin layers of silicon by means of epitaxy or silicon nitride (SiN), silicon oxide (SiO), silicon oxynitride (SiON), silicon oxycarbide (SiOC) or silicon carbide (SiC). In these fields of application, impurities of the starting compounds even in the ppb to ppt range interfere and can lead to undesirable changes in the properties of the layers produced therefrom. Said compounds in the required purity are sought-after starting compounds in the field of electronics, the semiconductor industry, solar cell production and in the pharmaceutical industry.

The high-purity or ultrahigh-purity chemicals are employed, in particular, in the semiconductor industry where ultrahigh-purity or “electronic grade” silicon and germanium compounds are at present already used on a scale of hundreds of tonnes. These are, in particular, trichlorosilane, silicon tetrachloride or tetraethoxysilane, which are used for producing epitactic silicon layers on an Si wafer or for producing silicon dioxide insulation layers on electronic chips.

Comparatively small container sizes are often employed in order to minimize the risks of possible contamination, for example when the contents are used. The container size has in the past been matched essentially to the following process step, so that a container would be emptied in this step if possible. Furthermore, it was unfortunately not always possible to avoid contamination, for example by hydrolysis products which can be formed by repeated opening and closing of a container, by means of this procedure.

In addition, due to the increased throughputs achieved nowadays in the respective production steps, the risk of product contamination of the high-purity and ultrahigh-purity compounds on changing the containers within a running process and refilling them has risen considerably.

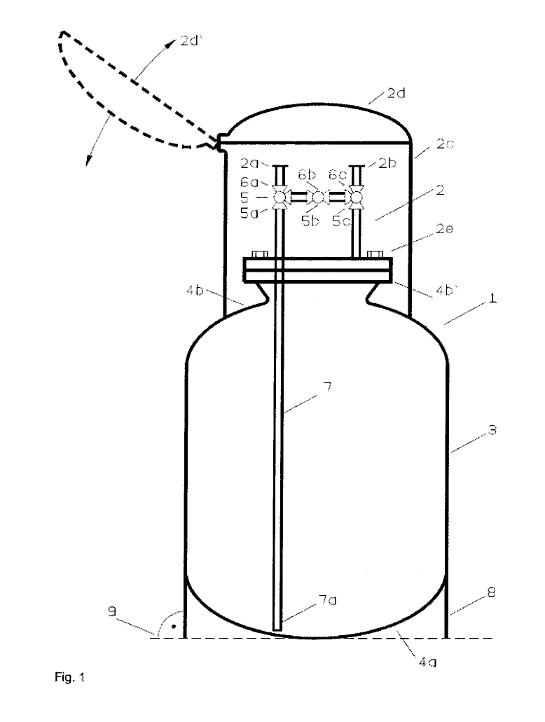

Containers for the handling and transport of high-purity or ultrahigh-purity chemicals, as disclosed, for example, in U.S. Pat. No. 5,465,766, U.S. Pat. No. 5,878,793, US 2002/0020449 A1, WO 00/79170 A1 or WO 2009/053134 A1, cf. FIG. 1, are known at present but these at best have a flushing system with two valves and a valve for cross-flushing (“cross-purge”) and standardized connections; it is not ensured that even after a flushing operation before refilling, residues (hereinafter also referred to as dregs) of the preceding product still remain in the container and can thus lead to considerable contamination of new high-purity and ultrahigh-purity products to be handled, although carrying out a flushing operation is generally known to a person skilled in the art or prescribed by operating instructions.

It was an object of the present invention to provide a further system which makes it possible, in a simple and economical way, to minimize further the contamination risk in the handling and the transport of high-purity and ultrahigh-purity chemicals.

The object is achieved according to the invention by the features of the independent claims. In addition, the features of preferred embodiments of the present invention are described in the dependent claims.

Thus, it has surprisingly been found that the use of an empty container (1), hereinafter also referred to as container for short, for accommodating high-purity and ultrahigh-purity, air- and/or moisture-sensitive liquid or condensable compounds, which comprises essentially a vessel having a cylindrical wall (3) and, at the two ends of the cylindrical wall, a bottom (4a) and an upper closure (4b, 4b′), an associated connection unit (2) including shut-off/multiway and flushing system (5) and associated immersed tube (7), wherein the lower end of the immersed tube (7a) projects into a depression (4c) (indentation) which is made in or let into the bottom (4a) and represents the lowest point of the bottom and/or the lower end of the immersed tube (7a) is cut at an angle and the tip of the immersed tube cut at an angle (7b) comes to within less than 2 mm, preferably less than or equal to 1 mm, of the lowest point of the bottom (4a) or the tip of the immersed tube cut at an angle (7b) contacts this point, leads to a distinct minimization of contamination incidents when refilling the empty container.

Containers according to the invention thus advantageously make it possible to achieve a further significant reduction in the amount of dregs remaining in flushing operations or to reduce the number of flushing operations required for residue-free removal of contamination and thus also achieve a further minimization in the contamination risk in the case of refilling.

In addition, the containers according to the invention are, owing to their mechanical and chemical properties such as compressive strength, surface roughness of the inside of the vessel and surfaces which come into contact with product, the material used and also the freedom from leaks of the empty container including connection unit, advantageous for accommodating high-purity or ultrahigh-purity air- and/or moisture-sensitive liquids or condensable compounds.

Thus, economic damage caused by contamination in the handling of high-purity and ultrahigh-purity compounds, which, for example, is found within the framework of quality assurance or becomes known due to a customer complaint, can be significantly reduced further in a simple and economical way by use of an empty container according to the invention.

Such high-purity or ultrahigh-purity compounds can, without being restricted thereto, be, for example, silicon or germanium compounds. An example is monosilane (SiH₄) which is gaseous at room temperature and can be condensed under pressure into an empty container. This compound is spontaneously flammable and on contact with atmospheric oxygen reacts immediately to form silicon dioxide and water. Silicon tetrachloride, on the other hand, is a compound which is present as a liquid at room temperature and begins to fume and hydrolyse in the presence of moist air. Further high-purity or ultrahigh-purity compounds can be trichlorosilane, dichlorosilane, monochlorosilane, hexachlorodisilane, hexamethyldisilazane, tetraethoxysilane, methyltriethoxysilane, dimethyldimethoxysilane, germanium tetrachloride or monogermane, to name only a few, which all have to be handled with exclusion of moisture and/or under a protective gas atmosphere.

For the purposes of the present invention, high-purity or ultrahigh-purity compounds are compounds whose degree of contamination is in the ppb range; in the case of ultrahigh-purity, impurities are present only in the ppt range and below. Contamination of silicon or germanium compounds with other metal compounds is in the ppb range down to the ppt range, preferably in the ppt range. The required purity can be checked by means of GC, IR, NMR, ICP-MS or by resistance measurement or GD-MS after deposition of the silicon or germanium.

The present invention accordingly provides empty containers (1) for accommodating high-purity and ultrahigh-purity, air- and/or moisture-sensitive liquid or condensable compounds, having a cylindrical wall (3) and, at the two ends of the cylindrical wall, a bottom (4a) and an upper closure (4b, 4b′), and an associated connection unit (2) including shut-off/multiway and flushing system (5) and associated immersed tube (7), which are characterized in that

the lower end of the immersed tube (7a) is cut at an angle and the tip of the immersed tube cut at an angle (7b) comes to within less than 2 mm, preferably less than or equal to 1 mm, of the lowest point of the bottom (4a) or the tip of the immersed tube cut at an angle (7b) contacts this point
or
the lower end of the immersed tube (7a) projects into a depression (4c) (indentation) which is made in the bottom (4a) and represents the lowest point of the bottom and
the lower end of the immersed tube (7a) comes to within less than 2 mm, preferably less than or equal to 1 mm, of the lowest point of the bottom (4a), i.e. in the indentation,
or
the lower end of the immersed tube (7a) projects into a depression (4c) (indentation) which is made in the bottom (4a) and represents the lowest point of the bottom and the lower end of the immersed tube (7a) is cut at an angle and the tip of the immersed tube cut at an angle (7b) comes to within less than 2 mm, preferably less than or equal to 1 mm, of the lowest point of the bottom (4a), i.e. in the indentation, or the tip of the immersed tube cut at an angle (7b) contacts this point.

As regards the spacing between the lower end of the immersed tube, i.e. the tip of the immersed tube, and said lowest point of the bottom (4a), the following numerical values in mm may be mentioned: 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1, 0.09, 0.08, 0.07, 0.06, 0.05, 0.04, 0.03, 0.02 and 0.01.

Thus, the container (1) comprises such a vessel or interior space (interior volume) for accommodating high-purity and ultrahigh-purity, air- and/or moisture-sensitive liquid or condensable compounds, which is essentially formed by the cylindrical wall (3) and, at the two ends of the cylindrical wall, a bottom (4a) and an upper closure (4b, 4b′) and can be closed tightly by means of the connection unit (2).

The connection unit (2) in turn comprises not only the connections (2a, 2b) and an immersed tube (7) but advantageously also a shut-off/multiway and flushing system (5) having two or more shut-off or flushing elements (5a, 5b or 5c), where these are valves, preferably diaphragm valves, and/or cocks, preferably two-way (6b) or three-way cocks (6a, 5c) and also a flange system (2e) which can be connected or bolted onto the upper closure (4b, 4b′).

The connection unit (2) thus has, for charging, emptying and for flushing of the empty container (1), not only the connections (2a, 2b) but also a shut-off/multiway and flushing system (5) having shut-off elements (5a, 5b, 5c); in particular, the connection unit (2) has a multiway system (6a, 6b, 6c) which preferably has three shut-off elements in the form of two three-way cocks (6a, 6c) and a two-way cock (6b), where the connection (2a) is connected via a tube to shut-off element (5a) and this is connected to the immersed tube (7) which in turn extends through the flange lid (2e) into the vessel and the outside of the immersed tube (7) is sealed against the passage in the flange lid (2e), for example by welding. In addition, the shut-off element (5a) is advantageously connected via a tube to the shut-off element (5b) which in turn is connected via a tube to shut-off element (5c). Furthermore, the shut-off element (5c) is connected via a tube to a passage in the flange lid (2e), where said passage in the flange lid ensures, like the immersed tube (7), access to the interior of the empty container vessel. Furthermore, the shut-off element (5c) is connected via a tube to the connection (2b). As shut-off element, it is also possible to use a valve or a cock or a closure, with the use of a valve or a multiway cock being preferred. In particular, three- and two-way cocks and, as valve, a membrane valve, a ball valve or a bellows valve are suitable.

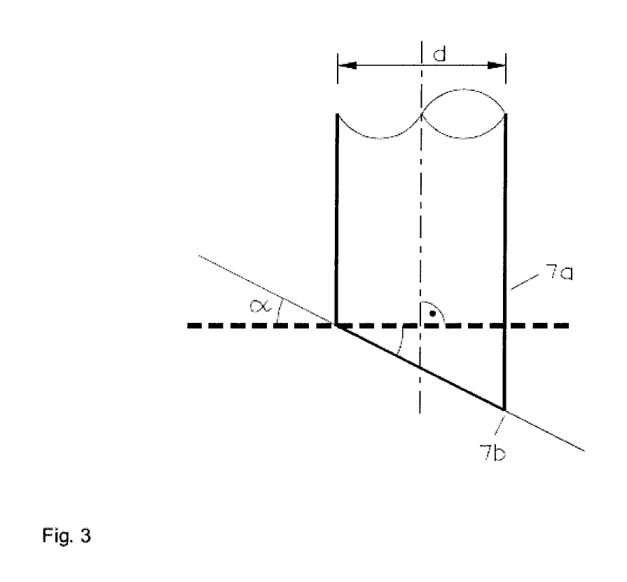

In a preferred embodiment of the present invention, the lower end of the immersed tube (7a) is cut at an angle (a) from the cross-sectional area based on the diameter (d) of the immersed tube of from to 1° to 60°, preferably from 2° to 45°, particularly preferably from 3° to 30°, very particularly preferably from 4° to 25°, in particular from 5° to 20°, to name again some of the abovementioned values for the angle [° ]: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, cf. FIG. 3. Here, the internal diameter (dᵢ) of the immersed tube can advantageously be from 1 to 50 mm, preferably from 2 to 40 mm, particularly preferably from 3 to 30 mm, particularly preferably from 4 to 25 mm, in particular from 5 to 15 mm, to name again some of the abovementioned values for the internal diameter [mm]; 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50.

To protect against soiling and damage, for example during transport of the containers, the connection unit (2) is advantageously arranged in a protective device (2c). The protective device (2c) usually comprises a cylindrical wall and a pivotable or flippable lid (2d, 2d′) and is arranged on the convex closure (4b, 4b′) around the connection unit (2). The connection unit is preferably completely enclosed by the protective device.

An empty container can generally have an internal volume of from 0.001 to 20 000 litres [I]. Empty containers or containers (1) according to the invention advantageously have an internal volume of from 0.1 to 1000 l, preferably from 0.5 to 500 l, particularly preferably from 1 to 300 l, very particularly preferably from 5 to 250 l, in particular from 10 to 100 l, to name again a few of the abovementioned values for the internal volume [l]: 0.1, 0.2, 0.25, 0.3, 0.4, 0.5, 0.6, 0.7, 0.75, 0.8, 0.9, 1, 1.25, 1.5, 1.75, 2, 2.5, 3, 3.5, 4, 5, 6, 7, 7.5, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 125, 130, 140, 150, 160, 170, 175, 180, 190, 200, 210, 220, 230, 240, 250, 275, 300, 325, 350, 375, 400, 425, 450, 475, 500, 550, 600, 650, 700, 750, 800, 850, 900, 950, 1000.

The shape of the empty container generally corresponds approximately to that of a cylindrical wall having a convex bottom and a convex upper closure, with the connection unit being assigned to the upper closure. This construction makes it possible to realize pressure-resistant empty containers in which a large pressure difference between internal pressure and external pressure can prevail, for example in the case of compounds condensed under superatmospheric pressure.

Thus, empty containers according to the invention are appropriately designed for an internal pressure up to 50 bar, preferably from 0.1 mbar to 25 bar, particularly preferably from 0.1 bar to 25 bar, very particularly preferably from 0.5 bar to 12 bar, in particular from 1 bar to 8 bar, to name again some of the abovementioned values for the internal pressure [bar]: 0.0001, 0.0005, 0.001, 0.005, 0.01, 0.05, 0.1, 0.2, 0.3, 0.4, 0.5, 0.6, 0.7, 0.7, 0.8, 0.9, 1.0, 1.1, 1.2, 1.3, 1.4, 1.5, 1.75, 2, 2.5, 3, 3.5, 4, 4.5, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50.

To avoid corrosion or reaction of an introduced compound with the material of the empty container and/or the connection unit, these are made of an inert material by means of which the desired pressure resistance can also be achieved.

The empty container of the invention, the connection unit and/or all parts which come into contact with the introduced high-purity or ultrahigh-purity chemicals are advantageously made of stainless steel, with the stainless steel preferably having been electropolished.

As stainless steel, preference is given, according to the invention, to corrosion-resistant stainless steels, for example 1.4301. Preference is also given to Mo-containing stainless steels, for example steels which begin with the material numbers 1.41, 1.44, 1.45 and 1.46. Thus, it is possible to use, by way of example but not exclusively, stainless steels of the group consisting of 1.4401, 1.4404, 1.4406, 1.4429, 1.4432, 1.4435, 1.4436, 1.4438, 1.4439, 1.4462, 1.4526, 1.4539, 1.4547, 1.4571 and special steels from the group consisting of Inconel, Incoloy, Hastelloy, Cronifer and Nicrofer, e.g. Nicrofer 3127 hMo, 5923 hMo, H-C4 or H-C22. For the purposes of the present invention, the stainless steels 1.4301, 1.4401, 316L, e.g. 1.4404, 1.4432 and also 1.4435 and 1.4571 are particularly preferred.

The stainless steel surface preferably has a roughness (Ra) of less than or equal to 1.0 μm. The roughness of the stainless steel surfaces is particularly preferably at a value (Ra) of ≦0.5 μm, very particularly preferably ≦0.2 μm, in particular ≦0.1 μm. Thus, it is possible, for example, to use cold-rolled stainless steels or advantageously electropolish the stainless steel used. The determination of the surface roughness can, by way of example but not exclusively, be carried out by means of profile-based methods such as tracing step methods and also, in particular, optical surface measuring methods (contact-free), e.g. confocal microscopy or white light interferometry, to name only a few methods. Thus, the determination of the surface roughness can be carried out in accordance with EN ISO 25178.

To enable the empty container or container (1) to stand securing during charging, storage, handling, flushing or transport, it can have a support (8) on the wall (3) and/or on the optionally convex bottom (4a), which support can be formed by circularly arranged supports or a cylindrical wall. As an alternative, the empty container can be mounted on an appropriately shaped base or in a frame, preferably made of metal.

In addition, the empty container can be provided with recesses or fixing means which allow transfer by means of a crane. Particular preference is given to the empty container having a size of 850 litres upwards. The recesses or fixing means are preferably arranged on the cylindrical wall of the empty container.

As regards the correct use of containers according to the invention, the respective connection unit (2) can be configured so as to be able to be connected via at least two connections (2a, 2b) to a distillation column, transfer or measuring station, for example an in-process control apparatus, and/or a reaction apparatus, with a level measurement with switching function and also alarm function for minimum and/or maximum levels and also a sampling unit preferably being arranged between connection unit and distillation column, transfer station or a reaction apparatus.

An adapter for connecting the empty container to an apparatus for the production of high-purity or ultrahigh-purity compounds, in particular for connecting the empty vessel to a distillation column, can be additionally used on the premises of the party filling the container. Such an adapter can also advantageously be flushed, evacuated and/or flooded with inert gas via the shut-off/multiway and flushing system.

An additional adapter can likewise serve for connecting the container to an apparatus for the taking-off and/or consumption of high-purity or ultrahigh-purity compounds, in particular for connecting the container to a production plant for reaction of the high-purity or ultrahigh-purity compounds. An adapter and thus connected components provided on the part of the consumer can likewise be both flushed with inert gas and evacuated via the shut-off/multiway and flushing system.

The present invention likewise provides for the use of empty containers according to the invention for the storage, handling and/or transport of high-purity and ultrahigh-purity, air- and/or moisture-sensitive liquid or condensable compounds, in particular selected from the group consisting of high-purity and ultrahigh-purity silicon and/or germanium compounds and also metal-organic compounds, preferably from the group consisting of silicon tetrachloride, trichlorosilane, dichlorosilane, monochlorosilane, hexachlorodisilane, octachlorotrisilane, monosilane, disilane, trisilane, hexamethyldisilazane, trisilylamine, tetraethoxysilane, ethyl silicate, methyltriethoxysilane, dimethyldimethoxysilane, germanium tetrachloride, monogermane, triethyl borate, trimethyl borate, trimethyl phosphate, triethyl phosphate, tetramethylsilane, dimethyldimethoxysilane, octamethylcyclotetrasiloxane, tetramethylcyclotetrasiloxane, methylpyrrolidine alane, tetrakis[dimethylamino]titanium, tert-butylamido[tris(diethylamino)]tantalum, tert-butylamido[tris(diethylamino)]niobium, tantalum tetraethoxide, tetrakis[ethylmethylamino]hafnium, trimethylaluminium, tetrakis(ethylmethylamino)zirconium, cyclopentadienyltris[dimethylamino]zirconium, penta(dimethylamino)tantalum, ethylamido[tris(diethylamino)]tantalum, tetrakis(diethylamino)zirconium, dimethylaminoethoxytriethoxyzirconium.

The empty containers or containers according to the invention and their use thus allow a significant reduction in the risk of a significant amount of dregs remaining in the empty container after the flushing operation, which can otherwise lead, on refilling, to product contamination and thus to not inconsiderable economic damage.

FIG. 1 shows an empty container according to the prior art. Here, comparatively large amounts of dregs or of product can remain at the lowest point of the bottom region (4a) on emptying and flushing the container in view of the end of the immersed tube projecting vertically into the interior space.

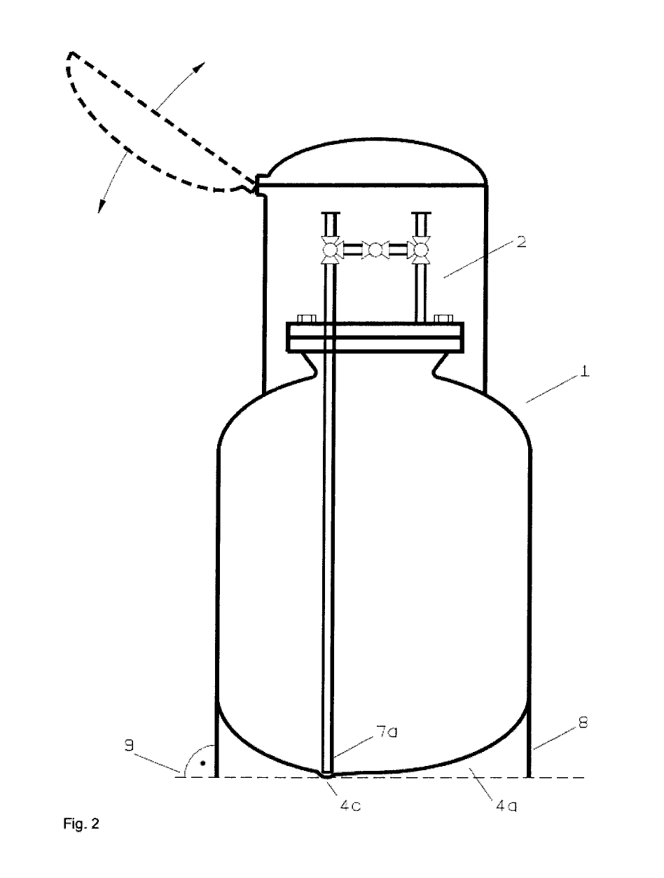

FIG. 2 shows a preferred embodiment of the present invention. Here, the end (7a) of the immersed tube (7) reaches into an indentation or depression (4c) which is comparatively small relative to the dimensions of the bottom (4a) and represents the lowest point in the bottom (4a), with the tip of the immersed tube (7a) coming to within less than 2 mm, preferably less than or equal to 1 mm, of the lowest point of the indentation (4c) in the bottom (4a) and thus advantageously ensuring minimization of dregs formation.

FIG. 3 shows a schematic depiction of an immersed tube (7b) cut at an angle.

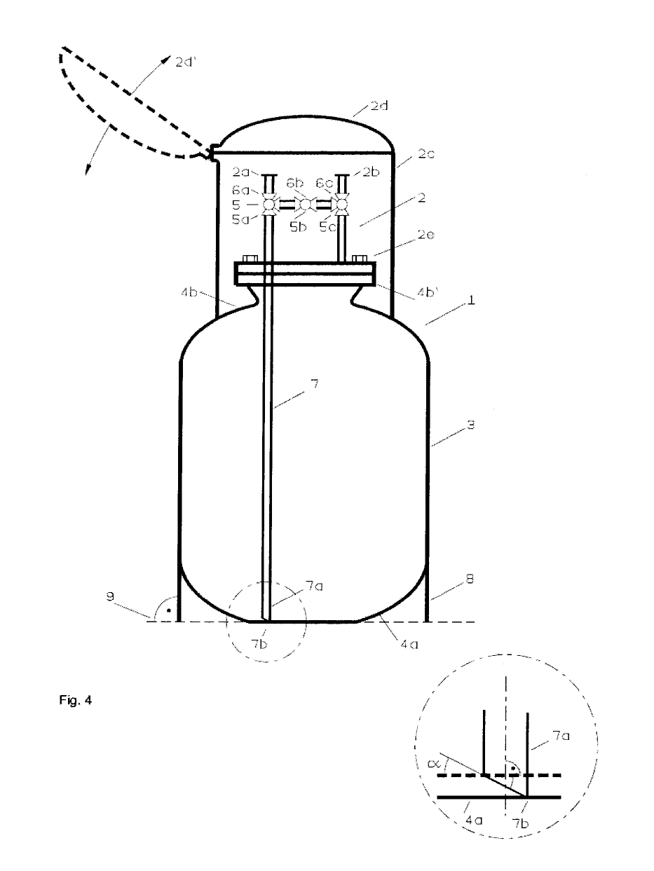

FIGS. 4 to 6 show further preferred embodiments according to the invention.

Thus, FIG. 4 shows a preferred embodiment in which the bottom (4a) is flat and the immersed tube (7a) projecting vertically into the interior space of the empty container is cut at an angle at its end (7b) and the tip of the immersed tube cut at an angle (7b) comes to within less than 2 mm, preferably less than or equal to 1 mm, of the lowest point of the bottom (4a) or the tip of the immersed tube cut at an angle (7b) contacts this point.

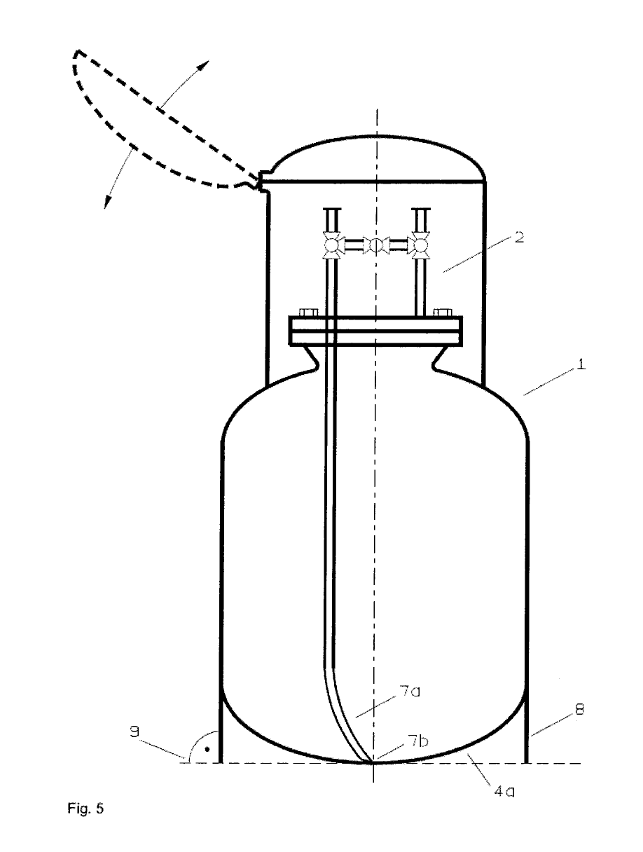

FIG. 5 shows a preferred variant in which the bottom (4a) is convex and the tip of the immersed tube cut at an angle (7b) comes to within less than 2 mm, preferably less than or equal to 1 mm, of the lowest point of the bottom (4a) or the tip of the immersed tube cut at an angle (7b) is in contact with this point.

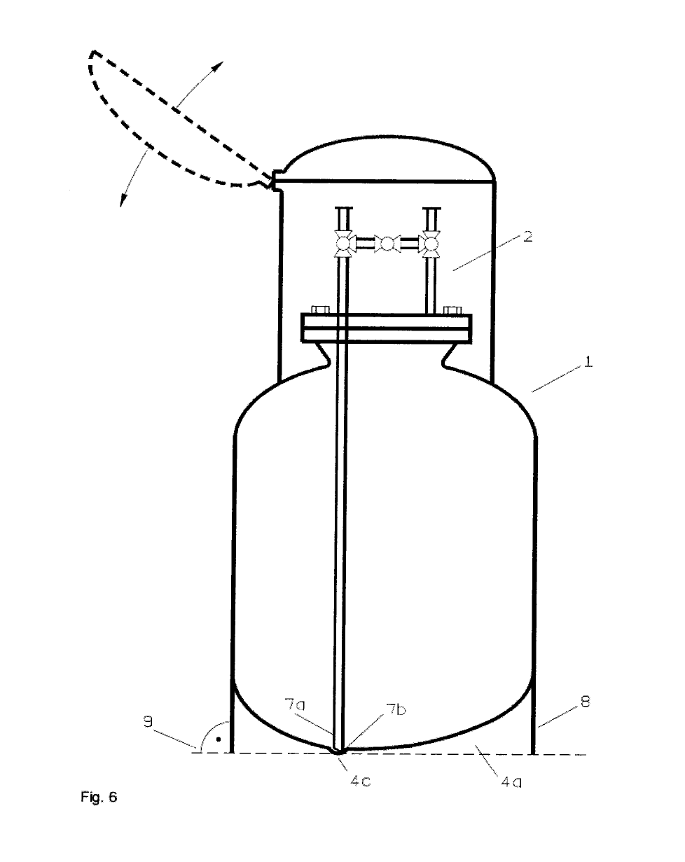

FIG. 6 depicts a further preferred embodiment in which the bottom (4a) is slightly convex and the end cut at an angle (7a) of the immersed tube (7) extends into an indentation or depression (4c) which is comparatively small relative to the dimensions of the bottom (4a) and represents the lowest point in the bottom (4a), with the tip of the immersed tube end cut at an angle (7b) coming to within less than 2 mm, preferably less than or equal to 1 mm, of the lowest point of the indentation (4c) in the bottom (4a) or the tip of the immersed tube cut at an angle (7b) contacting this point and thus making it possible, according to the invention, to ensure minimization of dregs formation in a simple and economical way.

The following example as per FIG. 4 illustrates the empty container or container according to the invention, without restricting the invention to this example:

The empty container (1) for accommodating air- and/or moisture-sensitive liquid or condensable compounds shown in FIG. 4 has a connection unit (2) having a shut-off/multiway and flushing system (5) with shut-off elements (5a, 5b, 5c), where the connection unit can be connected, for example, by means of a flange connection (2e) to the upper closure (4a, 4b′) of the empty container. The flange connection can additionally have a sealing ring and closure means in order to ensure hermetic closure of the empty container or container. The connection unit has a multiway valve system or general shut-off/multiway and flushing system (5) having three shut-off elements (6a, 6b, 6c) which, in one variant, each correspond to a three- (6a, 6c) or two-way cock (6b), hereinafter also referred to as valves for short. A connection from the valve (6c) to the empty container extends in the vicinity of the connection unit right into the empty container or container, and valve (6b) is arranged between the two valves (6a and 6c). In addition, the shut-off/multiway and flushing system (5) is associated with an immersed tube (7) which is associated with the valve (6a). The empty container or container has a cylindrical wall (3) and, at the two ends of the cylindrical wall, an essentially flat bottom (4a) which is curved towards the sides in the transition to the wall and a convex upper closure (4b) having a flange (4b′). All parts which come into contact with the high-purity or ultrahigh-purity compounds are made of electropolished stainless steel 316 L. The connection unit (2) is arranged in a protective device (2c, 2d). The support (8) makes setting down on flat surfaces (9) possible.

For flushing of the closure unit (2), valve (6c) is, for example, connected to a gas supply from which dry, optionally heated inert gas can be taken, for example to a helium source, and is in a position in which the gas supply communicates with valve (6b). Valve (6a) is connected to a gas uptake device and likewise brought into a position in which there is communication between the gas uptake device and the valve (6b). In this way, the connection unit (2), in particular the shut-off/multiway and flushing system (5), can be flushed with flushing gas, preferably inert gas, by introduction of gas via the valve (6c). If instead of the gas uptake device, a vacuum pump is connected to the valve (6a), flushing and evacuation of the connection unit can be carried out alternately.

To flush the empty container or container with inert gas in order to avoid hydrolysis or decomposition of high-purity or ultrahigh-purity compounds, valve (6a) is in such a position that it communicates with a gas uptake device and simultaneously with the interior space or volume of the empty container (1). Valve (6b) is in such a position that the connection between the valves (6a) and (6c) is closed. The valve (6c) is open into the empty container and connected in an open manner to a gas supply, for example a helium source. In this way, the gas, in particular helium, flows through the interior volume of the empty container (1), the immersed tube (7) and the connection unit. Flushing and evacuation of the empty container can be carried out alternately by alternate opening and closing of the valve (6c) when a vacuum pump is connected to the gas uptake device. In a corresponding manner, the gas space over liquid compounds in containers can also be flushed when the valve (6c) is connected to a gas uptake device and the valve (6a) is connected to a gas supply.

To fill the empty container with a liquid compound, the valve (6b) is in a position which prevents communication of the valves (6a and 6c). Liquid is introduced through the immersed tube into the empty container via the valve (6a) by means of pumping, pressing or flowing in via a difference in elevation. The gas/inert gas to be displaced flows out through the valve (6c) which is connected to a gas uptake device.

To empty the container, the valve (6b) remains in the above-described position and inert gas is pushed into the container via the open valve (6c) which is connected to a gas reservoir. The valve (6a) can be connected to a consuming apparatus via an adapter or directly. The liquid compound leaves the container through the immersed tube and through the open valve (6a) and the container is emptied in this way.

### LEGENDS TO FIGS. 1 TO 6

(1) Empty container with connection unit (2)
(2) Connection unit
(2a, 2b) Connections of the connection unit (2)
(2c) Protective device for connection unit (2)
(2d, 2d′) Lid of the protective device, made so as to be able to be flipped open
(2e) Flange lid of the connection unit (2)
(3) Cylindrical wall
(4a) Bottom
(4b) Upper closure with flange (4b′)
(4c) Depression or indentation in the bottom (4a)
(5) Shut-off/multiway and flushing system of the connection unit (2)
(5a, 5b, 5c) Shut-off elements of the shut-off/multiway and flushing system (5)
(6a, 6c) Three-way cocks
(6b) Two-way cock
(7) Immersed tube
(7a) Lower end of the immersed tube
(7b) Tip of the immersed tube cut at an angle, with angle (a) relative to the cross-sectional area of the immersed tube (7a) based on the diameter (d) of the immersed tube
(8) Support
(9) Surface for setting down, perpendicular to the earth's gravity

1. A container comprising
a cylindrical wall and,
at the two ends of the cylindrical wall, a bottom and an upper closure, and
an associated connection unit which comprises a shut-off/multiway and flushing system and associated immersed tube, wherein
a lower end of the immersed tube is cut at an angle, and
a tip of the immersed tube cut at an angle comes to within less than 2 mm of the lowest point of the bottom or the tip of the immersed tube cut at an angle contacts this point,
or
the lower end of the immersed tube projects into a depression made in the bottom and is the lowest point of the bottom and the lower end of the immersed tube comes to within less than 2 mm, of the lowest point of the bottom
or
the lower end of the immersed tube projects into a depression made in the bottom and represents the lowest point of the bottom and the lower end of the immersed tube is cut at an angle, and
the tip of the immersed tube cut at an angle comes to within less than 2 mm of the lowest point at the bottom or the tip of the immersed tube cut at an angle contacts this point.

2. The container according to claim 1, wherein
the lower end of the immersed tube is cut at an angle (α) from the cross-sectional area based on the diameter (d) of the immersed tube of from to 1° to 60°, and an internal diameter (dᵢ) of the immersed tube is from 1 to 50 mm.

3. The container according to claim 1, wherein
the connection unit has a shut-off/multiway and flushing system having two or more shut-off or flushing elements, where said shut-off or flushing elements are valves, and/or cocks.

4. The container according to claim 1, wherein
the connection unit is connected via a flange system to the upper closure.

5. The container according to claim 3, wherein
the connection unit is arranged in a protective device.

6. The container according to claim 1, wherein
the container has a support.

7. The container according to claim 1, wherein
the container and/or the connection unit are made from material that comprises stainless steel.

8. The container according to claim 7, wherein
the stainless steel is selected from the group consisting of 316 L, 1.4404, 1.4432, 1.4435, 1.4301, 1.4401 and 1.4571.

9. The container according to claim 7, wherein
the stainless steel is electropolished and the stainless steel surface has a roughness (Ra) of less than or equal to 1.0 μm.

10. The container according to claim 1, wherein
the container has an internal volume of from 0.1 to 1000 L.

11. The container according to claim 1, wherein
the container is designed for an internal pressure up to 50 bar.

12. The container according to claim 1, wherein
the connection unit can be configured so as to be able to be connected via at least two connections to a distillation column, transfer or measuring station and/or a reaction apparatus, with a level measurement with switching function and alarm function for minimum and/or maximum levels and a sampling unit arranged between the connection unit and distillation column, transfer station or a reaction apparatus.

13. A method for the storage, handling and/or transport of high-purity and ultrahigh-purity, air- and/or moisture-sensitive liquid or condensable compound, said method comprising
placing the compound inside of the container from claim 1, wherein
the compound is selected from the group consisting of high-purity and ultrahigh-purity silicon and/or germanium compounds, metal-organic compounds, silicon tetrachloride, trichlorosilane, dichlorosilane, monochlorosilane, hexachlorodisilane, octachlorotrisilane, monosilane, disilane, trisilane, hexamethyldisilazane, trisilylamine, tetraethoxysilane, ethyl silicate, methyltriethoxysilane, dimethyldimethoxysilane, germanium tetrachloride, monogermane, triethyl borate, trimethyl borate, trimethyl phosphate, triethyl phosphate, tetramethylsilane, dimethyldimethoxysilane, octamethylcyclotetrasiloxane, tetramethylcyclotetrasiloxane, methylpyrrolidine alane, tetrakis[dimethylamino]titanium; tert-butylamido[tris(diethylamino)]tantalum, tert-butylamido[tris(diethylamino)]niobium, tantalum tetraethoxide, tetrakis[ethylmethylamino]hafnium, trimethylaluminium, tetrakis(ethylmethylamino)zirconium, cyclopentadienyltris[dimethylamino]zirconium, penta(dimethylamino)tantalum, ethylamido[tris(diethylamino)]tantalum, tetrakis(diethylamino)zirconium, dimethylaminoethoxytriethoxyzirconium.

14. The container according to claim 3, wherein the valves are diaphragm valves and the cocks are two-way or three-way cocks.
